(19) United States
(12) Patent Application Publication
(10) Pub. No.: US 2023/0376861 A1
(43) Pub. Date: Nov. 23, 2023

(54) Artificial Intelligence Based Upsell Model

(71) Applicant: Oracle International Corporation, Redwood Shores, CA (US)

(72) Inventors: Andrew VAKHUTINSKY, Sharon, MA (US); Jorge Luis Rivero PEREZ, Naples, FL (US); Kirby BOSCH, Ann Arbor, MI (US); Jason G BRYANT, Las Vegas, NV (US); Natalia KOSILOVA, State College, PA (US)

(73) Assignee: Oracle International Corporation, Redwood Shores, CA (US)

(21) Appl. No.: 17/746,282

(22) Filed: May 17, 2022

(51) Int. Cl. G06Q 10/02; G06Q 30/06; G06Q 50/12

(52) U.S. Cl. CPC G06Q 10/02; G06Q 30/0631; G06Q 50/12

(57) ABSTRACT

Embodiments upsell a hotel room selection by providing a first plurality of hotel room choices, each first plurality of hotel room choices comprising a first type of hotel room and a corresponding first price. Embodiments receive a first selection of one of the first plurality of hotel room choices. In response to the first selection, embodiments provide a second plurality of hotel room choices, the second plurality of hotel room choices comprising a subset of the first types of hotel room choices and a corresponding optimized price that is different from the respective corresponding first price.

One embodiment is directed generally to a computer system, and in particular to a computer system that develops an artificial intelligence based upsell model.

### BACKGROUND INFORMATION

Increased competition in the hotel industry has caused hoteliers to look for more innovative revenue management policies, such as personalized pricing and recommendations. Over the past few years, hoteliers have come to understand that not all guests are equal and a traditional one-size-fits-all policy might prove to be ineffective. Therefore, a need exists for hotels to profile their guests and offer them the right product/service at the right price with the goal of maximizing their profit.

### SUMMARY

Embodiments upsell a hotel room selection by providing a first plurality of hotel room choices, each first plurality of hotel room choices comprising a first type of hotel room and a corresponding first price. Embodiments receive a first selection of one of the first plurality of hotel room choices. In response to the first selection, embodiments provide a second plurality of hotel room choices, the second plurality of hotel room choices comprising a subset of the first types of hotel room choices and a corresponding optimized price that is different from the respective corresponding first price.

### BRIEF DESCRIPTION OF THE DRAWINGS

Further embodiments, details, advantages, and modifications will become apparent from the following detailed description of the embodiments, which is to be taken in conjunction with the accompanying drawings.

FIG. 1 is an overview block diagram of a hotel reservation system in accordance to embodiments of the invention.

FIG. 2 is a block diagram of a computer server/system in accordance with an embodiment of the present invention.

FIG. 3 is a flow diagram that illustrates the functionality of hotel reservation system of FIG. 1 in accordance to embodiments.

FIG. 4 illustrates some example text descriptions and the resultant derived unigrams, bigrams and trigrams in accordance to embodiments.

FIG. 5 illustrates an example frequency map for the bigrams in accordance to embodiments.

FIG. 6 illustrates L1 and L2 regularizations in accordance to embodiments.

FIG. 7 is an overview block diagram of the functionality of the system of FIG. 1 in in accordance to embodiments of the invention.

FIG. 8 is an architectural diagram of the offer optimization model of FIG. 7 in accordance to embodiments.

FIG. 9 is a flow diagram that illustrates the functionality of hotel reservation system of FIG. 1 in accordance to embodiments.

FIG. 10 illustrates an example output solution from the functionality of FIG. 9 in accordance to embodiments of the invention.

FIGS. 11-14 illustrate a sequence of events for when a customer is presented with upsell choices in accordance to embodiments of the invention.

### DETAILED DESCRIPTION

Embodiments utilize artificial intelligence (“AI”) in fitting a supervised learning model to predict demand for the hotel rooms based on their features including price, display placement, and static features such as size, configuration, number of beds, etc. Embodiments first extract the room features from their natural language descriptions. As the number of the features may be very large, embodiments then perform a feature selection based on the relevance of the room features to the historic upsell choices made by the hotel guest. Embodiments then apply a discrete-choice model based on the multinomial logit approach to predict customer upsell choices. The personalization of the model is achieved by accounting for the booking attributes of the hotel guests such as length of stay, arrival date, number in the party, and how much in advance the room is booked.

Upselling is a sales technique used to motivate a customer/user/guest to purchase a more expensive option than the one that the customer initially chooses. When carefully implemented, it can considerably improve revenues. Upselling can be especially useful in industries with “perishable” inventories, such as the hotel and airline industries. Hotel rooms and airplane seats are date-specific products. If a room for a particular date is not booked by that date, the potential revenue that could have been generated is lost permanently. Much like dynamic pricing, upselling can be used to balance supply and demand for multiple classes of products.

The present disclosure focuses on embodiments used for the hospitality industry application. However, the generated upsell model in accordance with embodiments can also be employed in any setting where upselling is used (e.g., car rentals, airlines, etc.).

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

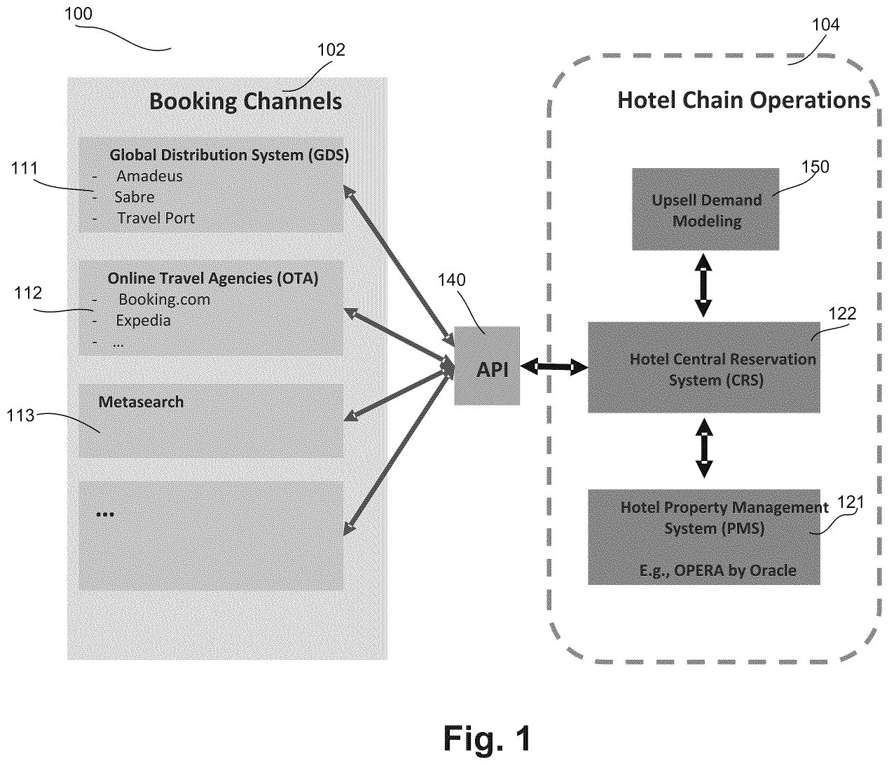

FIG. 1 is an overview block diagram of a hotel reservation system 100 in accordance to embodiments of the invention. FIG. 1 includes booking channels 102 that a potential hotel customer may interact with to reserve a hotel room. The channels include a Global Distribution System (“GDS”) 111, including “Amadeus”, “Sabre”, “Travel Port”, etc., Online Travel Agencies (“OTA”) 112, including “Booking.com”, “Expedia”, etc., Metasearch sites 113, and any other means for a customer to reserve a hotel room, including a website maintained by a hotel chain or individual hotel.

Each hotel chain operations 104 is accessed by an Application Programming Interface (“API”) 140 as a Web Service such as a “WebLogic Server” from Oracle Corp. Hotel chain operations 104 includes a Hotel Property Management System (“PMS”) 121, such as “OPERA Cloud Property Management” from Oracle Corp., a Hotel Central Reservation System (“CRS”) 122, and an Upsell Demand Model module 150 that interfaces with systems 121 and 122 to provide upsell demand modeling and all other functionality disclosed herein.

A hotel customer or potential hotel customer that uses system 100 to obtain a hotel room typically engages in a three stage booking process. First an area availability search is conducted. Multiple hotel chains are shown and hotel CRS 122 provides static data. The static data can include the min/max rate, available dates, etc.

If the booking customer selects a hotel, they go to the next step which is the property search, including a single hotel property, multiple rooms and rate plans. For the single hotel property, information may include room category description data, rate plan description and room price, each of which is shown in a specific order. The property search includes real-time availability data and results in the booking customer selecting a room. Once the room is selected, the final step is final booking and the reservation being guaranteed by a credit card or other form of payment.

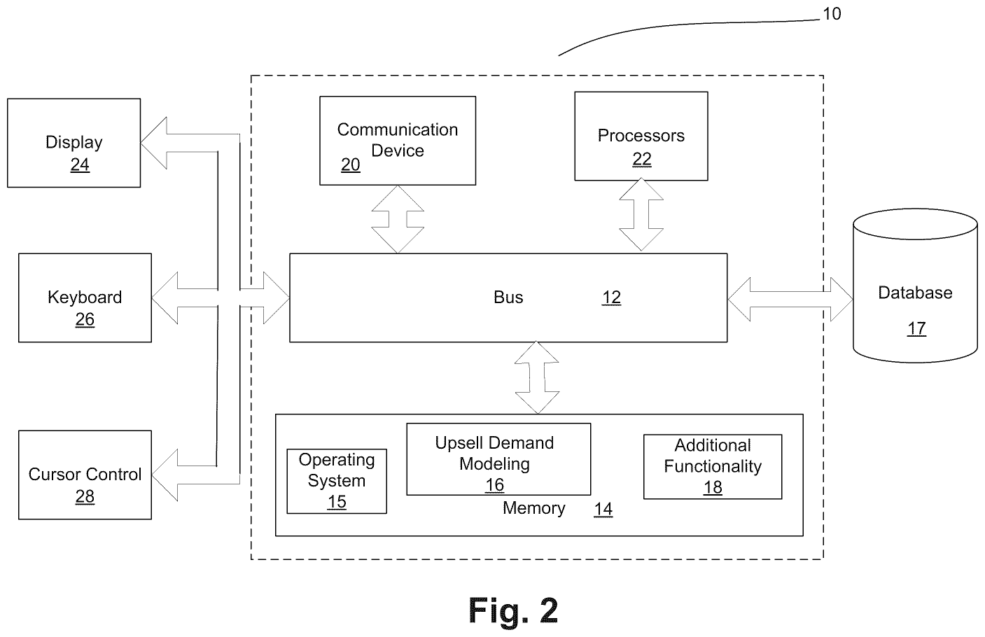

FIG. 2 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, when implemented as a web server or cloud based functionality, system 10 is implemented as one or more servers, and user interfaces such as displays, mouse, etc. are not needed. In embodiments, system 10 can be used to implement any of the elements shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include upsell demand modeling module 16 that that models upsell demand, to maximize the expected hotel room revenue, and all other functionality disclosed herein, including generating a predictive AI model in embodiments. As a hotel variable operating cost is relatively small, the expected revenue (i.e., the product of the room booking probability and room price) is the main optimization objective in embodiments. System 10 can be part of a larger system. Therefore, system 10 can include one or more additional functional modules 18 to include the additional functionality, such as the functionality of a Property Management System (“PMS”) (e.g., the “Oracle Hospitality OPERA Property” or the “Oracle Hospitality OPERA Cloud Services”) or an enterprise resource planning (“ERP”) system. A database 17 is coupled to bus 12 to provide centralized storage for modules 16 and 18 and store guest data, hotel data, transactional data, etc. In one embodiment, database 17 is a relational database management system (“RDBMS”) that can use Structured Query Language (“SQL”) to manage the stored data.

In one embodiment, particularly when there are a large number of hotel locations, a large number of guests, and a large amount of historical data, database 17 is implemented as an in-memory database (“IMDB”). An IMDB is a database management system that primarily relies on main memory for computer data storage. It is contrasted with database management systems that employ a disk storage mechanism. Main memory databases are faster than disk-optimized databases because disk access is slower than memory access, the internal optimization algorithms are simpler and execute fewer CPU instructions. Accessing data in memory eliminates seek time when querying the data, which provides faster and more predictable performance than disk.

In one embodiment, database 17, when implemented as a IMDB, is implemented based on a distributed data grid. A distributed data grid is a system in which a collection of computer servers work together in one or more clusters to manage information and related operations, such as computations, within a distributed or clustered environment. A distributed data grid can be used to manage application objects and data that are shared across the servers. A distributed data grid provides low response time, high throughput, predictable scalability, continuous availability, and information reliability. In particular examples, distributed data grids, such as, e.g., the “Oracle Coherence” data grid from Oracle Corp., store information in-memory to achieve higher performance, and employ redundancy in keeping copies of that information synchronized across multiple servers, thus ensuring resiliency of the system and continued availability of the data in the event of failure of a server.

In one embodiment, system 10 is a computing/data processing system including an application or collection of distributed applications for enterprise organizations, and may also implement logistics, manufacturing, and inventory management functionality. The applications and computing system 10 may be configured to operate with or be implemented as a cloud-based networking system, a software-as-a-service (“SaaS”) architecture, or other type of computing solution.

Embodiments employ a Multinomial Logit (“MNL”) model in order to formulate and predict the customer's reaction to a promotional offer(s) made after the an initial choice. The benefits of employing a structural model like MNL is that it offers an intuitive interpretation of the estimation results. Therefore, with the help of the MNL model, embodiments can estimate the monetary value of the different features that the promotional offer consists from. These estimates are not only useful for the optimal pricing of the offers, but may provide an important “big picture” strategic information to the hotel management.

Embodiments offer more structure than known machine learning methods that are usually used to estimate choice probabilities in this case. First, it is guaranteed that the more offers the customer sees, the less is the probability that any individual offer j would be chosen. Moreover, the higher is the price of the promotional offer, the lower would be its choice probability, and, correspondingly, the probability that the customer would stick to the initial choice is higher.

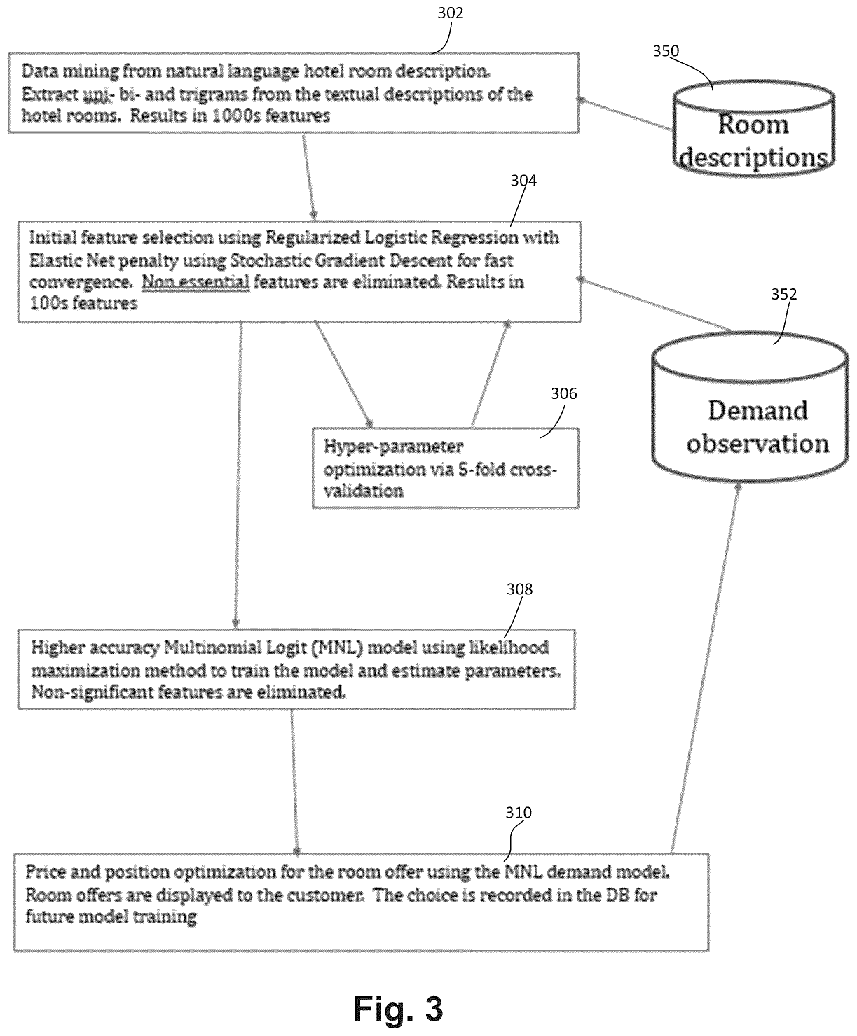

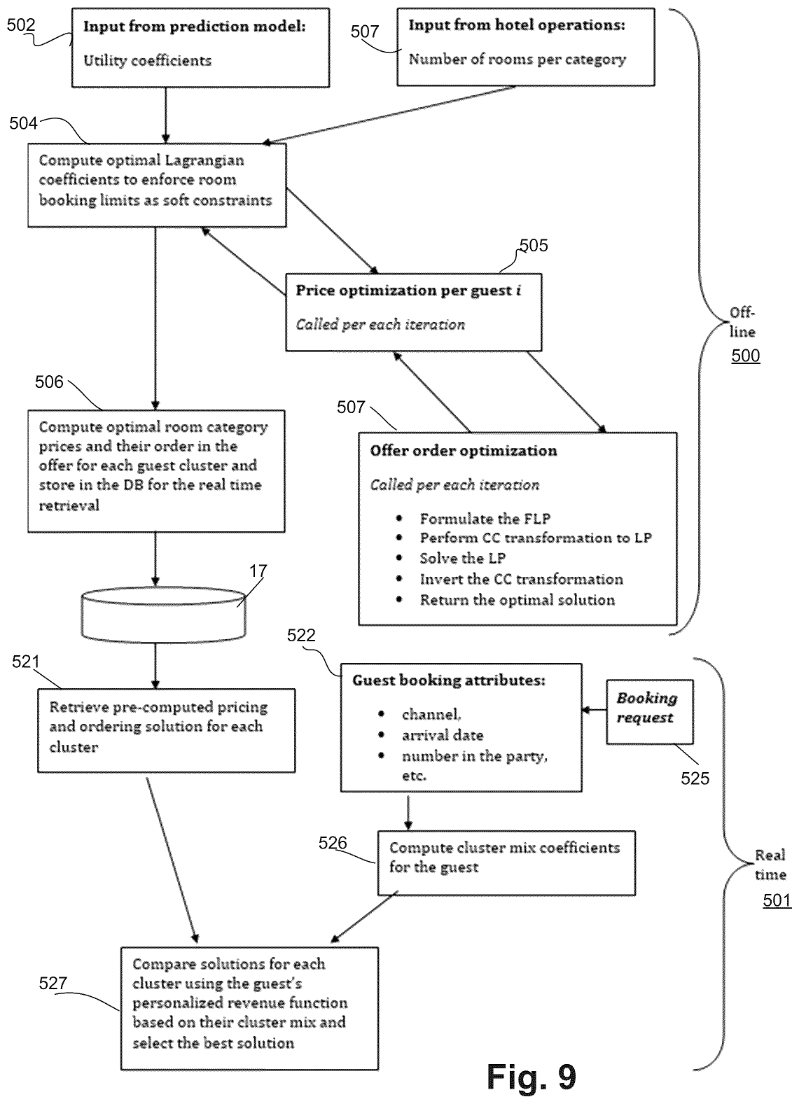

FIG. 3 is a flow diagram that illustrates the functionality of hotel reservation system 100 of FIG. 1 in accordance to embodiments. In one embodiment, the functionality of the flow diagram of FIG. 3 (and FIG. 9 below) is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

Feature Extraction

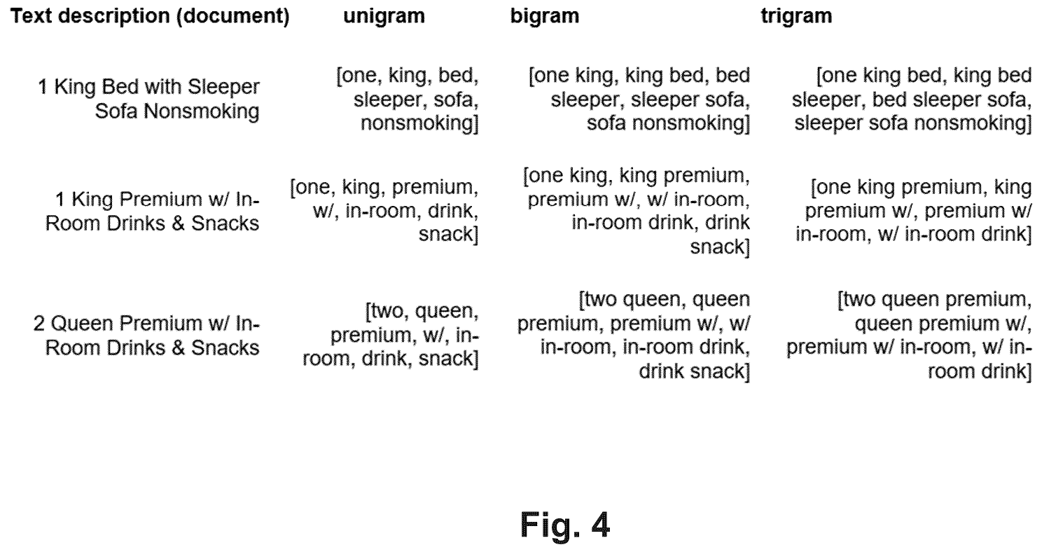

At 302, features are extracted using data mining from the natural language hotel room descriptions. The hotel room descriptions are retrieved from database 350 which in embodiments can be associated with a Hotel Property Management System (“PMS”) 121 of FIG. 1, such as “OPERA Cloud Property Management” from Oracle Corp. At 302, in embodiments, each room category description is considered as a separate document, which is tokenized (i.e., broken into separate words or tokens excluding common stop words such as articles and prepositions). After that, unigrams are formed as separate tokens, bigrams are formed as two consecutive tokens and trigrams as three consecutive tokens. FIG. 4 illustrates some example text descriptions and the resultant derived unigrams, bigrams and trigrams in accordance to embodiments.

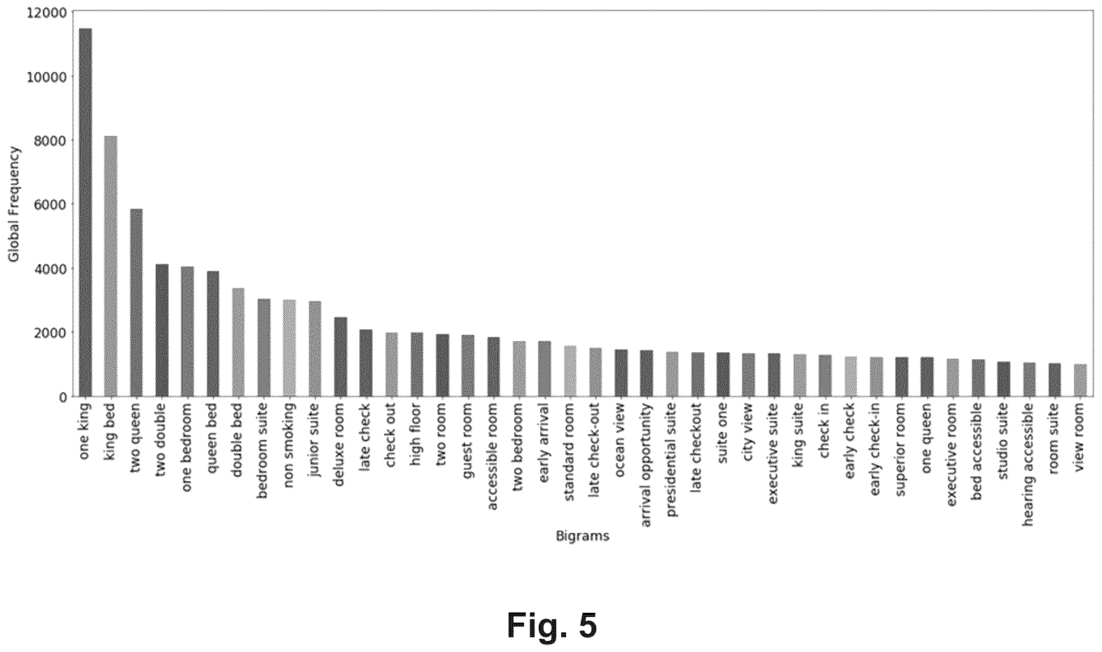

The unigrams, bigrams, and trigrams are used as features of the demand prediction model. These features are extracted from all documents forming the corpus of all category descriptions. As part of the data visualization, embodiments build a frequency map of the features. FIG. 5 illustrates an example frequency map for the bigrams in accordance to embodiments.

Initial Feature Selection

Because there may be hundreds of different room categories even in a medium-size hotel chain, the feature extraction at 302 generally results in extracting thousands of features from the corpus of category descriptions. Therefore, in order to make the model computationally tractable, the non-essential, duplicated or similar features are eliminated at 304 of FIG. 3.

Specifically, at 304 the features are selected by using a regularized logistic regression model. The model is fitted by likelihood maximization using a stochastic gradient descent (“SGD”) procedure. SGD is an iterative method for optimizing an objective function with suitable smoothness properties (e.g., differentiable or subdifferentiable). Each room category offer to a given user forms a single observation used in fitting the model. The output variable is a Boolean variable indicating whether the offer was accepted. The explanatory variables are the category features. The estimated parameters are the weights of the feature variables. In addition, embodiments add the category price and its display position in the offer as other two explanatory variables.

In embodiments, the regularized logistic regression model is as follows:

$${y}_{i j} ∼ Logit ( {\sum }_{k ∈ K} {α}_{k} {x}_{j k} - β {p}_{i j} - γ {z}_{i j} )$$

where
γᵢⱼ=Boolean variable indicating whether the offer for the room category j was accepted by customer i;
xⱼₖ=Boolean variable indicating presence of categorical feature k in room category j (e.g., ocean view or king-size bed) or the value of the numerical variable (e.g., room size measured in square feet);
pᵢⱼ=room category j price offered to customer i;
zᵢⱼ=display position of room category j price in the offer to customer i;
αₖ=feature k value (estimated parameter);
β=price sensitivity coefficient (estimated parameter);
γ=display position coefficient (estimated parameter).

Logistic regression models the choice probability as:

$${P}_{i j} = \frac{{e}^{{v}_{ij}}}{1 + {e}^{{v}_{ij}}}$$

where vᵢⱼ=utility of the choice j for customer i

$${v}_{i j} = {\sum }_{k ∈ K} {α}_{k} {x}_{j k} - β {p}_{i j} - γ {z}_{i j}$$

Therefore, given the observation customer set I, the likelihood of these observations is

$$L ( {α}_{k} , β , γ ) = {\prod }_{i ∈ I , j ∈ {J}_{i}} {( \frac{{e}^{{v}_{ij}}}{1 + {e}^{{v}_{ij}}} )}^{{y}_{ij}}$$

and the log-likelihood is

$$L L ( {α}_{k} , β , γ ) = log L = {\sum }_{i ∈ I , j ∈ {J}_{i}} ( {y}_{i j} {v}_{i j} - log ( 1 + {e}^{{v}_{ij}} ) )$$

The “most likely” values of the (αₖ, β, γ) parameters are estimated by maximizing the likelihood or equivalently the log-likelihood function:

(αₖ,β,γ)=argmax LL(αₖ,β,γ)

Since some of the variables may be very similar (or collinear), the solution to the maximization problem above may be unstable. In order to stabilize the solution and also eliminate some of the insignificant variables and their coefficients, embodiments use what is known as “Elastic Net regularization”, which is a combination of L1 and L2 regularizations, that is, adding a linear and quadratic penalty terms to the log-likelihood function as shown below where θ=(αₖ, β, γ) is the parameter vector.

L1 regularization:

$${max}_{θ} ( LL ( θ ) - μ {\sum }_{j} \vert {θ}_{j} \vert )$$

Equivalent to

$${max}_{θ} LL ( θ ) subject to : {\sum }_{j} \vert {θ}_{j} \vert < τ$$

The optimal solution may have some zero components corresponding to the dropped features.

L2 regularization:

$${max}_{θ} ( LL ( θ ) - \frac{λ}{2} {\sum }_{j} {θ}_{j}^{2} )$$

Equivalent to

$${max}_{θ} LL ( θ ) subject to : {\sum }_{j} {θ}_{j}^{2} < τ$$

Suppresses coefficient growth and adds numerical stability

Elastic Net:

$${max}_{θ} ( LL ( θ ) - ( μ {\sum }_{j} \vert {θ}_{j} \vert + \frac{λ}{2} {\sum }_{j} {θ}_{j}^{2} ) )$$

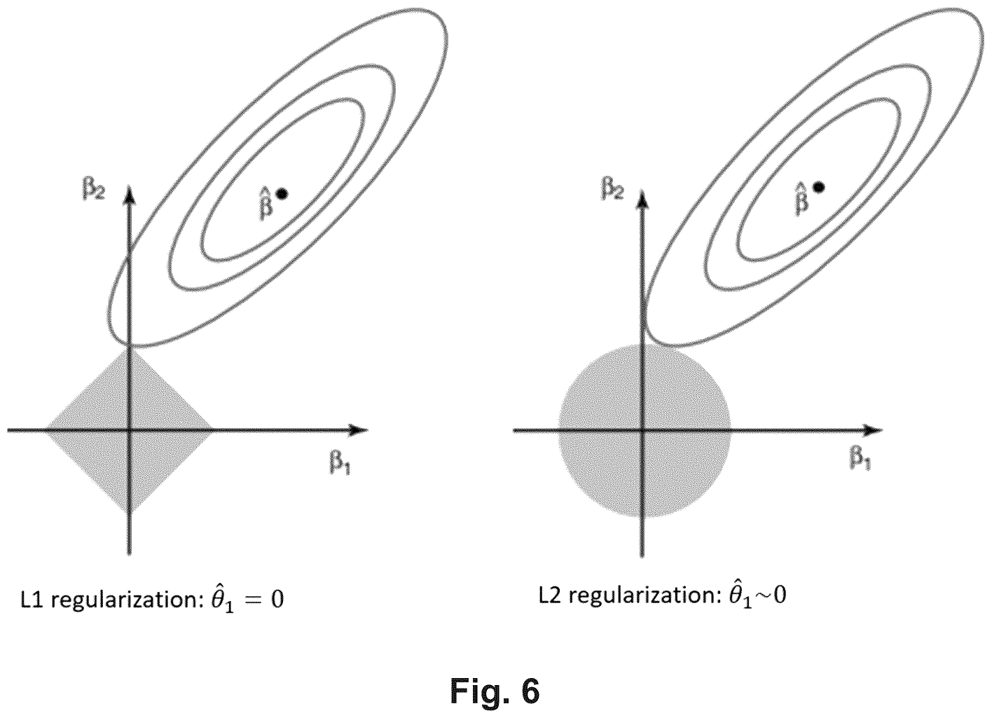

In the expressions above, μ and λ are the hyper-parameters obtained from the cross-validation based search as described below. FIG. 6 illustrates the L1 and L2 regularizations in accordance to embodiments.

Referring again to FIG. 3, at 306 and as disclosed above, two regularization parameters μ and λ need to be determined. This “tune-up” of the system needs to occur only once, and the results are stored in the configuration file. Therefore, 306 does not need to be implemented in additional iterations of the functionality of FIG. 3.

The search for the best combination of the parameters is performed on a two-dimensional grid. For each combination of the parameter values, the observation set is randomly split into five equal-sized parts. At each of the five iterations, one part is held out for out-of-sample validation, the other four are used for training the model. The parameter combination with the least out-of-sample error averaged over the five cross-validation iterations is selected to be used to fit the model. Denoting by M and ∧ the set of the hyper-parameter values, the functionality of 306 can be implemented using the following pseudocode:

```
Initialize: best prediction error ϵ* = +∞
for μ ∈ M:
      for λ ϵ Λ:
            split the observation set S = S₁ ∪ S₂ ∪ ... ∪ S₅
            for k = 1,...,5:
                  fit the model on the S\Sₖ observation set
                  compute the out-of-sample prediction error on Sₖ
            compute the average out-of-sample error ϵ_{μλ}
            if ϵ_{μλ} < ϵ*:
                  (μ*, λ*) = (μ, λ)
                  ϵ* = ϵ_{μλ}
return (μ*, λ*)
```

Generate Predictive Model

At 308, the set of features reduced at 306 are used to build a more sophisticated and more accurate predictive model. The limited number of features as compared to the initially extracted features at 304 ensures the computational tractability of the problem. Embodiments fit the MNL-based model and compute the confidence interval for the features.

Initially, embodiments implement a soft clustering approach in order to provide a personalized booking for the hotel guests. In this approach, each guest is assumed to belong to several clusters with a corresponding probability of belonging to each of the clusters. For example, a guest can be belong to a “business traveler” cluster with a probability of 30% and to “vacationer” cluster with a probability of 70%. The number of clusters is set as a configurable hyper-parameter and usually does not exceed four. Finding the optimal number of clusters, H, is a common issue in clustering problems. In practice, the number of clusters in the customer population is often unknown and needs to be determined from the data. If the number of clusters is too large, the proposed mixture model may be subject to overfitting and reduced prediction accuracy. Embodiments treat this issue as a model selection problem and employ the information criteria method for choosing the number of clusters to maximize certain information criteria.

Embodiments begin with soft clustering of the guests by using a Fuzzy C-means algorithm, which is a form of fuzzy clustering (also referred to as “soft clustering” or “soft k-means”) in which each data point can belong to more than one cluster. The soft clustering is an unsupervised learning algorithm based on the customer booking parameters known at the time of booking request such as arrival date, length of stay, number in the party, corporate discounts, etc., as disclosed in U.S. patent application Ser. No. 16/784,634, the incorporation of which is hereby incorporated by reference, and can be specified as follows:
1. Given the set of data points αᵢ corresponding to the booking parameters of customer i, use the preselected number of clusters H.
2. Randomly select πᵢₕ probabilities of each data point αᵢ to be in the cluster h.
3. Repeat until the algorithm has converged:
   a. Compute the centroid for each cluster:

$${c}_{h} = \frac{{\sum }_{i ∈ I} {π}_{i h}^{2} {a}_{i}}{{\sum }_{i ∈ I} {π}_{i h}^{2}}$$

b. For each data point i, compute its probability to be in the cluster h:

$${π}_{i h} = \frac{{‖ {a}_{i} - {c}_{h} ‖}^{- 2}}{{\sum }_{k ∈ H} {‖ {a}_{i} - {c}_{h} ‖}^{- 2}}$$

Further at 308 the probability of selecting an alternative j by the customer i is modeled as discrete choice among multiple alternatives according to an Multinomial Logit (“MNL”) model, expressed as follows:

$${P}_{i j} = {\sum }_{h ∈ H} {π}_{i h} \frac{{e}^{{v}_{ij}^{h}}}{1 + {\sum }_{ℓ ∈ {J}_{i}} {e}^{{v}_{i ℓ}^{h}}} ∀ j ∈ {J}_{i}$$

where Jᵢ is an ordered set of choice alternatives offered to customer i and πᵢₕ are the soft clustering coefficients that are computed as described above.

Similar to the definition of vᵢⱼ utility function, cluster-specific utility is defined as:

$${v}_{i j}^{h} = {\sum }_{k ∈ K} {α}_{k}^{h} {x}_{j k} - {β}^{h} {p}_{i j} - {γ}^{h} {z}_{i j}$$

If the product positions in the set is not known, the display positioning variable zᵢⱼ is omitted. In order to properly scale the estimated parameters, it is assumed that the utility of the no-purchase case is zero, which is accounted for by 1 in the denominator of the expression for the probability.

As the historic demand observations 352 includes both the offer set and the selection of the offer by each individual (including rejection of any offer), the likelihood function becomes:

$$L = {\prod }_{i = 1}^{N} {\prod }_{j ∈ M} {( \frac{{e}^{{v}_{ij}}}{1 + {\sum }_{ℓ ∈ {J}_{i}} {e}^{{v}_{i ℓ}}} )}^{{δ}_{ji}}$$

where δⱼᵢ=1 if customer i chooses product j and zero otherwise. Equivalently, the log-likelihood function can be maximized as follows:

$$L L = {\sum }_{i = 1}^{N} log {\sum }_{h ∈ H} {π}_{h} {\prod }_{j ∈ M} {( \frac{{e}^{{v}_{ij}}}{1 + {\sum }_{ℓ ∈ {J}_{i}} {e}^{{v}_{i ℓ}}} )}^{{δ}_{ji}}$$

The above model can be reformulated as an “upsell” model to be used for embodiments in determining optimized upselling according to embodiments as follows: Let some item kᵢ be the initial choice of the customer i. Denote by Cᵢ the set of items that were offered for upsell, with prices changed from some pᵢⱼ to p*ᵢⱼ. Now the choice set of the customer i consists of all the items in Cᵢ, and the initially chosen item kᵢ, which has the original price pₖ_{ᵢ}. Choosing item kᵢ in this setting would mean that the customer was not willing to accept any of the promotional offers that were presented.

The probability that an upsell offer for an item j will be accepted by a customer i who initially selected item kᵢ is as follows:

$${P}_{i}^{j} = {\sum }_{h ∈ H} {π}_{i h} \frac{{e}^{{v}_{ij}^{h} - {β}^{h} ( {p}_{ij}^{*} - {p}_{ij} )}}{{e}^{{v}_{{ik}_{i}}^{h}} + {\sum }_{ℓ ∈ {C}_{i}} {e}^{{v}_{i ℓ}^{h} - {β}^{h} ( {p}_{i ℓ}^{*} - {p}_{i ℓ} )}}$$

And the probability that none of the offers will be accepted and the customer i will end up with their initial choice is the following:

$$1 - {\sum }_{j ∈ {C}_{i}} {P}_{i}^{j} = {\sum }_{h ∈ H} {π}_{i h} \frac{{e}^{{v}_{ij}^{h}}}{{e}^{{v}_{{ik}_{i}}^{h}} + {\sum }_{ℓ ∈ {C}_{i}} {e}^{{v}_{i ℓ}^{h} - {β}^{h} ( {p}_{i ℓ}^{*} - {p}_{i ℓ} )}}$$

Therefore, on a data set with N individuals, where each individual i after selecting some item kᵢ was shown a set of multiple promotional offers Cᵢ, out of which the individual is supposed to select a single upsell offer, the upsell model parameters can be estimated by maximizing the following likelihood function:

$$L = {\prod }_{i ∈ N} {\prod }_{j ∈ {C}_{i}} {( {\hat{{P}_{i}}}^{j} )}^{{δ}_{ij}} \times {( 1 - {\sum }_{j ∈ {C}_{i}} {P}_{i}^{j} )}^{{\overline{δ}}_{i}}$$

Where δᵢⱼ is an indicator for whether the customer i requests offer j, and δ̅ᵢ=1 if none of the offers were requested by the customer, and equal to 0 otherwise.

The above upsell model can be trained in embodiments as disclosed in using the approach disclosed in U.S. patent application Ser. No. 16/784,634.

The above upsell MNL model can be written as:

γᵢ˜MNL(vᵢⱼ,j∈Jᵢ)

where γᵢ is a categorical variable indicating the i^{th} customer's choice.

If the hotel booking data is coming from several similar hotels, instead of pooling the data and estimating the model parameters as common for all groups or estimating the parameters separately for all hotels, embodiments use hierarchical MNL regression. Embodiments formulate the model using Bayesian inference principles. Specifically in formulating the model, the posterior distribution of the parameters is modeled as:

γᵢ˜MNL(vᵢⱼ^{m},j∈Jᵢ)

where m∈M is the index of the hotel and m=m(i), that is, each observation belongs to a single hotel:

$${v}_{i j}^{h m} = {\sum }_{k ∈ K} {α}_{k}^{h m} {x}_{j k} - {β}^{h m} {p}_{i j} - {γ}^{hm} {z}_{i j}$$

The fundamental modeling assumption is that parameters for different hotels are coming from the same normal distributions. For example:

αₖ^{hm}˜N(μₖ,σₖ)

β^{hm}˜N(μ_{β},σ_{β})

γ^{hm}˜N(μ_{γ},σ_{γ})

and all μ and σ are estimated parameters.

Embodiments use a Bayesian Inference model with the following priors:

μₖ,μ_{β},μ_{γ},˜N(0,100)

σₖ,σ_{β},σ_{γ},˜Γ(2,1)

Therefore, embodiments use essentially non-informative prior for μ and Gamma distribution as a prior for σ parameter.

At the conclusion of 308, the features with the confidence intervals containing zero are eliminated from the upsell model as insignificant and the resulting upsell model is used at 310 to optimize the prices and display ordering of the upsell offers.

Historic demand observations 352 include both initial offers and upsell offers together with the customer offer selections (including rejection of any offers) at the given historic price. The historic data 352 is used to train the upsell model in order to estimate its parameters. The price and position optimization that follows at 310 is for the “new” incoming offers. At 310, as described below, embodiments determine the optimal prices and positions using the previously estimated model parameters.

Optimization of Pricing and Display Ordering

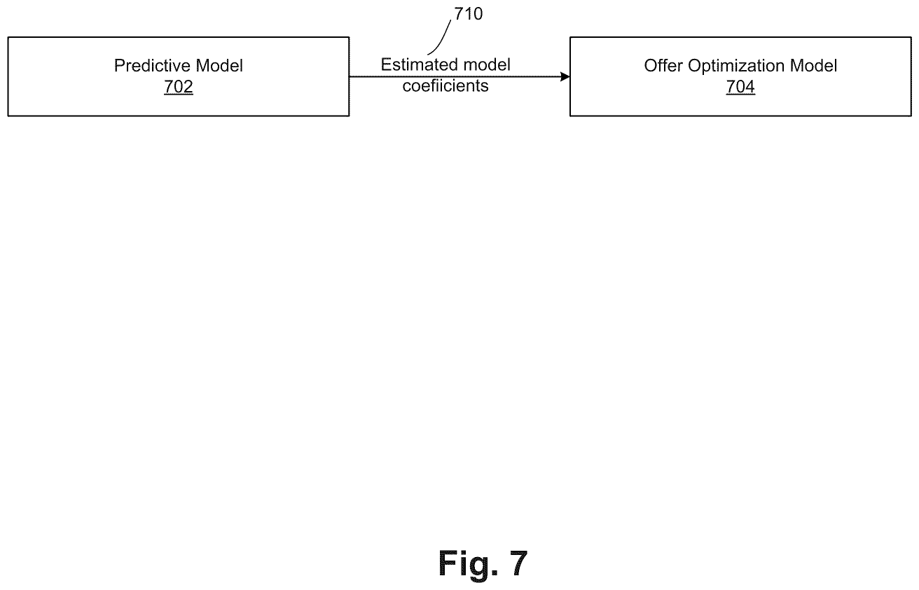

At 310, the model at 308 and estimated parameters estimated α, β, γ parameters from 308 are provided as input to optimize pricing and the display ordering of upsell offers. FIG. 7 is an overview block diagram of the functionality of system 100 of FIG. 1 in in accordance to embodiments of the invention. In one embodiment, predictive model 702, generated at 308 of FIG. 3, generates estimated model coefficients 710 (e.g., in embodiments described below, estimated α, β, γ coefficients). Predictive model 702 is a customer behavior model that determines the probability of booking each product (i.e., room-rate combination) based on its order in the list, price, and other factors including the customer persona. Predictive model 702 estimates coefficients by solving an optimization problem with coefficients as decision variables. The objective of predictive model 702 is to maximize the fitting of the model with given model variables' values.

Estimated model coefficients 710 are input to an offer optimization model 704, which generates the optimized pricing and ordering and display of hotel room choices. Given the estimated coefficient values, optimization model 704 finds the model variables' values to maximize the objective (i.e., maximize revenues).

Offer optimization model 704 uses decision variables of the prices and positions of the room options (upsell offers) offered to the customer/guest. The decision variables include: (1) which room options to offer; (2) how to price the room options; and (3) how to arrange the room options. Offer optimization model 704 provides an optimized personalized searching recommendation offer and the ordering of the rate-grouped room types.

Optimized Display Ordering

In general, embodiments of offer optimization model 704 are an optimization system that provides a personalized display of the hotel booking options in real-time, with the objective to maximize the expected revenue using the probability computed from a multinomial logit (“MNL”) discrete-choice predictive model 702 trained on the historical observations. In order to personalize the displayed options, embodiments use “soft” clustering of the customer population by assuming that a customer belongs to each cluster with some probability that is predicted by a soft clustering model. The number of clusters is given as a hyper-parameter.

The optimization problem for a given mix of clusters is formulated as a set of fractional-linear programming problems, which are transformed using the Charnes-Cooper transformation (disclosed in Charnes, A.; Cooper, W. W. (1962), “Programming with Linear Fractional Functionals”. Naval Research Logistics Quarterly. 9 (3-4)) into equivalent linear-programming problems that can be solved by a standard linear-programming package. Since the solution for a given mix of clusters cannot be obtained in “real-time” (e.g., less than 10 ms), embodiments pre-compute the optimal solutions for the points in the multidimensional grid of the fixed cluster mixes. When the cluster mix of a booking customer is determined by predictive model 702, a nearest point in the grid is found and the pre-computed solution is displayed.

Embodiments enable some degree of the hotel capacity control when the forecast for the future demand for each room category is known. In this case, embodiments can enforce the capacity constraint by using Lagrangian multipliers that are used as a virtual cost of overbooking the rooms. These multipliers are adjusted by using a variant of the gradient search in order to equate the projected demand to the capacity of each room category. As the result, the revenue derived from the high-demand room categories at the risk of over-booking is input into the optimization problem as artificially reduced by the Lagrangian multipliers, thus making it less appealing for booking in the optimal solution.

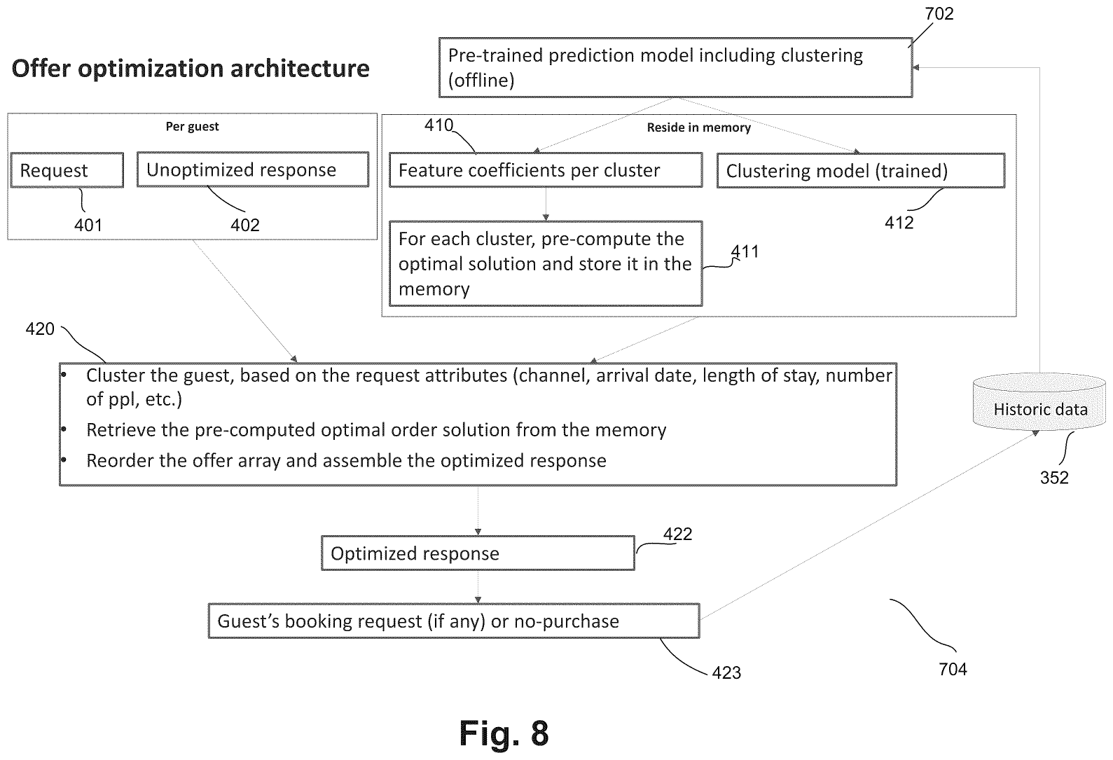

FIG. 8 is an architectural diagram of offer optimization model 704 of FIG. 7 in accordance to embodiments. Offer optimization model 704 receives, as input, pre-trained predictive/prediction model 702. Using prediction model 702 as input, offer optimization model 704 stores in memory (e.g., database 17) feature coeficients per cluster 410 and the clustering model 412, which is pre-trained as part of prediction model 702. In embodiments, as disclosed in more detail below, feature coeficients per cluster 410 include utility intercept αⱼ^{h} as well as cluster-specific price coefficient β^{h} and position effects γₘ^{h}.

On a per guest/customer basis, offer optimization model 704 receives a request 401 for reserving a hotel room and provides an unoptimized response 402. Response 402 provides an unoptimized list of room choices to be optimized by the embodiments. The initial unoptimized list of room choices is not presented to the hotel guest.

At 420, model 704 clusters the guest, based on the request attributes (channel, arrival date, length of stay, number of ppl, etc.), retrieves the pre-computed optimal order solution from the memory and reorder the offer array and assembles the optimized response. At 422, the optimized response is generated and presented as an optimized display of hotel room choices. At 423, the guest provides a booking request, based on selecting a choice from the optimized list, or no-purchases. The selection at 423 is stored in database 352 as historic data or demand observation, and is provided to prediction model 702 (at 304 of FIG. 3) which uses the selection as an additional iteration to further train or retrain prediction model 702.

Deterministic Version

In general, the set of the future room-booking hotel guests, I, is not known exactly although it can be forecasted with some degree of certainty. However, in embodiments it is assumed that it is exactly known, which allows embodiments to solve a deterministic version of the problem. The closer to the arrival, the more accurate the guest count normally becomes, which will be reflected in the adjustments of the Lagrangian relaxation penalty as shown below.

Embodiments assume there are I customers, J products (i.e., hotel room/rate combinations) and M positions in the offer. Each customer belongs to each of H groups with the given probability πᵢₕ. Each product is characterized by a set of given parameters/coefficients that includes its utility intercept αⱼ^{h} as well as cluster-specific price coefficient β^{h} and position effects γₘ^{h}, respectively, where α, β, γ coefficients are estimated from the predictive model 302, described in detail below. The utility of choosing product j by a customer from cluster h is expressed as a linear function vᵢⱼₘ^{h}=αⱼ^{h}−β^{h}pᵢⱼ+γₘ^{h}, where pᵢⱼ is the price of product j in the product offer as seen by customer i. For all i, j, pᵢⱼ is in [p, p̅]. Further, as not all products may be shown to a customer, xᵢⱼₘ ∈{0,1} is the offer inclusion variable indicating whether product j is assigned to position m and offered to customer i. Assuming that each customer can choose only one product and the probability of their choice is described by the multinomial logit (“MNL”) function of product utilities, the total revenue can be expressed as:

$$R = {\sum }_{i , j} {p}_{ij} \cdot {\sum }_{h} {π}_{i h} \frac{{\sum }_{m} {v}_{i j m}^{h} ( {p}_{i j} ) {x}_{i j m}}{1 + {\sum }_{{j}^{′} = 1}^{J} {\sum }_{{m}^{′} = 1}^{M} {v}_{{ij}^{′} {m}^{′}}^{h} ( {p}_{{ij}^{′}} ) {x}_{{ij}^{′} {m}^{′}}}$$

where vᵢⱼₘ^{h}=exp(vᵢⱼₘ^{h})=exp(αⱼ^{h}−β^{h}pᵢⱼ+γₘ^{h}).

The overall problem formulation is:

$$P : max R = {\sum }_{i , j} {p}_{i j} \cdot {\sum }_{h} {π}_{i h} \frac{{\sum }_{m} {v}_{i j m}^{h} ( {p}_{i j} ) {x}_{i j m}}{1 + {\sum }_{{j}^{′} = 1}^{J} {\sum }_{{m}^{′} = 1}^{M} {v}_{{ij}^{′} {m}^{′}}^{h} ( {p}_{{ij}^{′}} ) {x}_{{ij}^{′} {m}^{′}}} \qquad ( 1 )$$

$$s . t .$$

$${\sum }_{i} {\sum }_{j ∈ {J}_{c}} {\sum }_{h} {π}_{i h} \frac{{\sum }_{m} {v}_{i j m}^{h} ( {p}_{i j} ) {x}_{i j m}}{1 + {\sum }_{{j}^{′} = 1}^{J} {\sum }_{{m}^{′} = 1}^{M} {v}_{{ij}^{′} {m}^{′}}^{h} ( {p}_{{ij}^{′}} ) {x}_{{ij}^{′} {m}^{′}}} \leq {B}_{c} , ∀ c ∈ C \qquad ( 2 )$$

$${\sum }_{j} {x}_{i j m} \leq 1 , ∀ i ∈ I , m ∈ M \qquad ( 3 )$$

$${\sum }_{m} {x}_{i j m} \leq 1 , ∀ i ∈ I , j ∈ J {x}_{i j m} ∈ \{ 0 , 1 \} , ∀ i ∈ I , j ∈ J , m ∈ M \qquad ( 4 )$$

where B_{c} is the total availability of all products with resources in group c. In the hotel context, it is the number of rooms of the specific category c available on the specific night. The rooms from this category may be booked under different rate-plans (e.g., includes breakfast, fully refundable in case of cancellation, etc.) to form the product group J_{c} constrained by the availability of the rooms in the category. As products in different J_{c} sets correspond to different room categories, the J_{c} sets are disjoint. The constraints of equation 3 above ensure that at most one product is displayed in each position. The constraints of equation 4 above ensure that one product can be displayed in at most one position.

Let xᵢⱼₘ∈{0,1} be the offer inclusion variable indicating whether product j is assigned to position m and offered to customer i under price pᵢⱼ. Then denoting the hotel room capacity in category c by B_{c}, embodiments express the capacity constraint as follows:

$${\sum }_{i} {\sum }_{j ∈ {J}_{c}} {\sum }_{h} {π}_{i h} \frac{{\sum }_{m , k} {v}_{i j m}^{h} ( {p}_{i j} ) {x}_{ijmk}}{1 + {\sum }_{{j}^{′} = 1}^{J} {\sum }_{{m}^{′} = 1}^{M} {v}_{{ij}^{′} {m}^{′}}^{h} ( {p}_{{ij}^{′}} ) {x}_{{ij}^{′} {m}^{′}}} \leq {B}_{c} .$$

Introducing Lagrange Multipliers {λ_{c}}_{c=1}^{C} as nonnegative constants, the Lagrange relaxation of the capacity constraints can be expressed by adding the capacity constraint violation to the objective function as shown in equation 5 below, Embodiments formulate a Lagrange Relaxation problem as indicated below:

$$max {\sum }_{i , j} {\sum }_{h} {π}_{i h} \frac{{\sum }_{m , k} {p}_{ij} \cdot {v}_{i j m}^{h} ( {p}_{i j} ) {x}_{ijm}}{1 + {\sum }_{{j}^{′} = 1}^{J} {\sum }_{{m}^{′}} {v}_{{ij}^{′} {m}^{′}}^{h} ( {p}_{{ij}^{′}} ) {x}_{{ij}^{′} {m}^{′}}} + {\sum }_{c} {λ}_{c} ( {B}_{c} - {\sum }_{i} {\sum }_{j ∈ {J}_{c}} {\sum }_{h} {π}_{i h} \frac{{\sum }_{m , k} {v}_{i j m}^{h} ( {p}_{i j} ) {x}_{ijmk}}{1 + {\sum }_{{j}^{′} = 1}^{J} {\sum }_{{m}^{′}} {v}_{{ij}^{′} {m}^{′}}^{h} ( {p}_{{ij}^{′}} ) {x}_{{ij}^{′} {m}^{′}}} ) \qquad ( 5 )$$

$$s . t . {\sum }_{j} {x}_{i j m} \leq 1 , ∀ i , m$$

$${\sum }_{m} {x}_{i j m} \leq 1 , ∀ i , j$$

$${x}_{i j m} ∈ \{ 0 , 1 \} , ∀ i , j , m$$

Which is equivalent to:

$$( {P}^{R} ) : max {\sum }_{i} {\sum }_{c} {\sum }_{j ∈ {J}_{c}} {\sum }_{h} {π}_{i h} \frac{{\sum }_{m} ( {p}_{i j} - {λ}_{c} ) {v}_{i j m}^{h} ( {p}_{i j} ) {x}_{i j m}}{1 + {\sum }_{{j}^{′} = 1}^{J} {\sum }_{{m}^{′}} {v}_{{ij}^{′} {m}^{′}}^{h} ( {p}_{{ij}^{′}} ) {x}_{{ij}^{′} {m}^{′}}}$$

$$s . t . {\sum }_{j} {x}_{i j m} \leq 1 , ∀ i , m$$

$${\sum }_{m} {x}_{i j m} \leq 1 , ∀ i , j$$

$${x}_{i j m} ∈ \{ 0 , 1 \} , ∀ {i}_{1} j , m$$

Single Cluster Case

Since the solution of the problem for the cluster mixture is not computationally tractable, embodiments use the following heuristic to obtain a near-optimal solution: Obtain the assortment optimization solutions for each individual cluster and then, among these solutions, select the one that maximizes the expected revenue for the given cluster mix. The solutions for each individual cluster are pre-computed off-line and later retrieved in real time to speed up the computation, as shown below at 527 of FIG. 9. Obtaining a solution for a single cluster is disclosed as follows:

If embodiments with only have one cluster, the problem becomes:

$$( {P}^{R S} ) : {max}_{x ∈ {ℝ}_{+}^{J M K}} {\sum }_{c} {\sum }_{j ∈ {J}_{c}} \frac{{\sum }_{m , k} ( {p}_{ij} - {λ}_{c} ) {v}_{j m} ( {p}_{ij} ) {x}_{j m}}{1 + {\sum }_{{j}^{′} = 1}^{J} {\sum }_{{m}^{′}} {v}_{{j}^{′} {m}^{′}}^{h} ( {p}_{{ij}^{′}} ) {x}_{{j}^{′} {m}^{′}}} \qquad ( 6 )$$

$$s . t . {\sum }_{j} {x}_{j m} \leq 1 , ∀ m \qquad ( 7 )$$

$${\sum }_{m} {x}_{j m} \leq 1 , ∀ j \qquad ( 8 )$$

$${x}_{j m} ∈ \{ 0 , 1 \} , ∀ j , m \qquad ( 9 )$$

Since vⱼₘ(pₖ)≥0, the objective function is a fractional-linear function and is quasi-convex. Constraints of equations 7 and 8 above are totally unimodular. The integral constraints can be relaxed. Then, by the Charnes-Cooper transformation, (P^{LS}) is equivalent to

$$( C {C}^{R S} ) : {max}_{( y , {y}_{0} ) ∈ {ℝ}_{+}^{J M K + 1}} {\sum }_{c} {\sum }_{j ∈ {J}_{c}} {\sum }_{m , k} ( {p}_{j} - {λ}_{c} ) {v}_{j m} ( {p}_{j} ) {y}_{j m k} \qquad ( 10 )$$

$$s . t . {\sum }_{j} {y}_{j m} \leq {y}_{0} , ∀ m \qquad ( 11 )$$

$${\sum }_{m} {y}_{j m} \leq {y}_{0} , ∀ j \qquad ( 12 )$$

$${y}_{j m} \leq {y}_{0} , ∀ j , m \qquad ( 13 )$$

$${y}_{0} + {\sum }_{{j}^{′} = 1}^{J} {\sum }_{m} {v}_{j m} ( {p}_{j} ) {y}_{j m} = 1 \qquad ( 14 )$$

Therefore, the problem is reduced to solving a linear-programming problem.

Let (y*,γ₀) be a basic optimal solution of (CC^{RS}), then let

$${x}_{j m} = \frac{{y}_{jm}^{*}}{{y}_{0}^{*}}$$

for (P^{RS}) it is shown that x* satisfy the constraints of equations 7 and 8 above, and also gives the same optimal value. As disclosed below, it can be illustrated that

$$\frac{{y}_{jm}^{*}}{{y}_{0}^{*}} ∈ \{ 0 , 1 \} .$$

Specifically, in a basic optimal solution (y*,γ₀) to (CC^{RS}),

$$\frac{{y}_{jm}^{*}}{{y}_{0}^{*}} ∈ \{ 0 , 1 \}$$

for all j∈[J], k∈[K], m∈[M], so the solution

$$\frac{{y}^{*}}{{y}_{0}^{*}}$$

is optimal to (P^{RS}).

As proof of the above, for the solution (y*,γ₀), defining the slack variables for the first three sets of constraints results in:

$${\sum }_{j , k} {y}_{j m}^{*} + {s}_{m}^{1 *} = {y}_{0}^{*} , ∀ m \qquad ( 15 )$$

$${\sum }_{m} {y}_{j m}^{*} + {s}_{j}^{2 *} = {y}_{0}^{*} , ∀ j \qquad ( 16 )$$

$${y}_{j m}^{*} + {s}_{j m}^{3 *} = {y}_{0}^{*} , ∀ j , m \qquad ( 17 )$$

$${y}_{0}^{*} + {\sum }_{{j}^{′} = 1} {\sum }_{m} {v}_{j m} ( {p}_{j} ) {y}_{j m}^{*} = 1 \qquad ( 18 )$$

By the constraints of equations 13 and 14, it is known that γ*₀>0. Denote [symbol] ⁰={(j,m): γ*ⱼₘ is basic and sⱼₘ^{3*} is basic}, [symbol] ¹={(j,m): γ*ⱼₘ is basic and sⱼₘ^{3*} is nonbasic} and [symbol] ²={(j,m): γ*ⱼₘ is nonbasic and sⱼₘₖ^{3*} is basic}. | [symbol] ⁰|+| [symbol] ¹|+| [symbol] ¹|=JM. It is claimed that γ*ⱼₘ ∈{0, γ*₀} for all (j,m) ∈ [symbol] ⁰. Define [symbol] ={m:sₘ¹* is nonbasic}, [symbol] ={j:sⱼ²* is nonbasic}. Then the number of basic variables in (y*,γ*₀,s^{1*},s²*,s³*) is 1+2| [symbol] ⁰|+| [symbol] ¹|+| [symbol] ²|+M+J−| [symbol] |−| [symbol] |=| [symbol] ⁰|+JM+M+J−| [symbol] |−| [symbol] |=1+JM+M+J. Therefore, | [symbol] ⁰|+| [symbol] |+| [symbol] |. Moreover, sₘ¹*=0 for m ∈ [symbol] , sⱼ²*=0 for j∈ [symbol] , and γ*ⱼₘ=0 for (j, m, k)∈ [symbol] ². And for all (j,m)∈ [symbol] ¹, γ*ⱼₘ=γ*₀. So for m∈ [symbol] ,j∈ [symbol] , there is the following:

$$\begin{matrix}{\sum }_{j , k : ( j , m , k ) ∈ {𝒩}^{0}} {y}_{j m}^{*} = ( 1 - {\sum }_{j , k : ( j , m ) ∈ {𝒩}^{1}} 1 ) {y}_{0}^{*} \\ {\sum }_{m , k : ( j , m ) ∈ {𝒩}^{0}} {y}_{j m k}^{*} = ( 1 - {\sum }_{m , k : ( j , m ) ∈ {𝒩}^{1}} 1 ) {y}_{0}^{*}\end{matrix}$$

Since | [symbol] ⁰|=| [symbol] |+| [symbol] |, the solution for the above two equations is unique and given by the inverse of the coefficient matrix and the right-hand side vector. The coefficient matrix is unimodular, so its inverse only has {−1,0,1}. Therefore, γ*ⱼₘₖ must be an integer multiple of γ*₀. The result is γ*ⱼₘₖ∈{0, γ*₀} for all (j,m)∈ [symbol] ⁰.

If (j,m)∈ [symbol] ⁰, then γ*ⱼₘₖ∈{0, γ*₀}. If (j,m)∈ [symbol] ¹, then γ*ⱼₘ=γ*₀. If (j,m)∈ [symbol] ², then γ*ⱼₘ=0. Therefore, ∀j,m, γ*ⱼₘ∈{0,γ*₀}.

Multiple Cluster General Case

The Lagrange Relaxation problem formulation shows that the maximization problem is independent on customers (on i). So (P^{R}) is equivalent to a sequence of subproblems (P^{R}ᵢ)ᵢ₌₁^{I}

$$\begin{matrix}( {P}_{i}^{R} ) : & max {\sum }_{c} {\sum }_{j ∈ {J}_{c}} {\sum }_{h} {π}_{i h} \frac{{\sum }_{m} ( {p}_{i j} - {λ}_{c} ) {v}_{i j m}^{h} ( {p}_{i j} ) {x}_{i j m}}{1 + {\sum }_{{j}^{′} = 1}^{J} {\sum }_{{m}^{′}} {v}_{i {j}^{′} {m}^{′}}^{h} ( {p}_{i {j}^{′}} ) {x}_{i {j}^{′} {m}^{′}}} \\ & s . t . {\sum }_{j} {x}_{i j m} \leq 1 , ∀ m \\ & {\sum }_{m} {x}_{i j m} \leq 1 , ∀ j \\ & {x}_{i j m} ∈ \{ 0 , 1 \} , ∀ j , m\end{matrix}$$

First, letting

$${y}_{i}^{h} = \frac{1}{1 + {\sum }_{j} {\sum }_{m} {v}_{i j m}^{h} ( {p}_{i j} ) {x}_{i j m}}$$

the problem (P^{R}ᵢ) can be posed as:

$$\begin{matrix} & max {\sum }_{c} {\sum }_{j ∈ {J}_{c}} {\sum }_{h} {π}_{i h} {\sum }_{m} ( {p}_{k} - {λ}_{c} ) {v}_{i j m}^{h} ( {p}_{i j} ) {x}_{i j m} {y}_{i}^{h} \\ & s . t . {\sum }_{j , k} {x}_{ijmk} \leq 1 , ∀ m \\ & {\sum }_{m , k} {x}_{ijmk} \leq 1 , ∀ j \\ & {y}_{i}^{h} + {\sum }_{j} {\sum }_{m , k} {v}_{i j m}^{h} ( {p}_{k} ) {x}_{ijmk} {y}_{i}^{h} = 1 , ∀ h \\ & 0 \leq {y}_{i}^{h} \leq 1 , ∀ j , m , k \\ & {x}_{ijmk} ∈ \{ 0 , 1 \} , ∀ j , m , k \\ Let {z}_{i j m k}^{h} = {x}_{i j m k} \cdot {y}_{i}^{h} & \\ ( {P}_{i}^{L} ) : & max {\sum }_{c} {\sum }_{j ∈ {J}_{c}} {\sum }_{h} {π}_{i h} {\sum }_{m , k} ( {p}_{k} - {λ}_{c} ) {v}_{i j m}^{h} ( {p}_{k} ) {z}_{i j m}^{h} \\ & s . t . {\sum }_{j , k} {x}_{ijm} \leq 1 , ∀ m \\ & {\sum }_{m , k} {x}_{i j m} \leq 1 , ∀ j \\ & {y}_{h} + {\sum }_{j} {\sum }_{m} {v}_{i j m}^{h} ( {p}_{i j} ) {z}_{i j m}^{h} = 1 , ∀ h \\ & {z}_{i j m}^{h} \leq {y}_{h} , ∀ j , m , h \\ & {z}_{i j m}^{h} \leq {x}_{ijm} , ∀ j , m , h \\ & {y}_{h} - {z}_{i j m}^{h} \leq 1 - {x}_{ijm} , ∀ j , m , h \\ & 0 \leq {y}_{h} \leq 1 , ∀ h \\ & {x}_{i j m} ∈ \{ 0 , 1 \} , ∀ j , m \\ & {z}_{i j m}^{h} \geq 0 , ∀ j , m , h\end{matrix}$$

This problem changes to solve a mixed-integer linear formulation.

Implementation Details

Embodiments solve the above problems using a linear-programming approximation algorithm, or a swap heuristic algorithm. Embodiments use the following heuristic algorithms with fixed prices and without capacity constraint:

$$\begin{matrix}( {P}^{R} ) : & max {\sum }_{j} {\sum }_{h} {π}_{h} \frac{{\sum }_{m} {p}_{j} {v}_{jm}^{h} {x}_{jm}}{1 + {\sum }_{{j}^{′} = 1}^{J} {\sum }_{{m}^{′}} {v}_{{j}^{′} {m}^{′}}^{h} {x}_{{j}^{′} {m}^{′}}} \\ & s . t . {\sum }_{j} {x}_{j m} \leq 1 , ∀ m \\ & {\sum }_{m} {x}_{j m} \leq 1 , ∀ j \\ & {x}_{j m} ∈ \{ 0 , 1 \} , ∀ j , m\end{matrix}$$

Linear-Programming Approximation
If there is only one cluster, the problem is equivalent to a linear-programming problem;
Solve the LP for each cluster to get H solutions (H is the number of clusters);
Calculate the expected revenue under the H solutions, choose the one with the largest expected revenue as the offer. (solved using Python linear programming “Pulp” in embodiments).

FIG. 9 is a flow diagram that illustrates the functionality of room hotel reservation system 100 of FIG. 1 in accordance to embodiments. The functionality of FIG. 9 includes an “off-line” portion 500 which uses the input from the pre-trained prediction model 702 in the form of the estimated parameter values of the model and pre-solves the single cluster problems for each individual cluster using the expected hotel bookings in anticipation of a customer requesting to reserve/book a hotel room. A “real-time” portion 501 is in response to the customer requesting a hotel room, and results in the optimized ordering of hotel room choices displayed to the customer.

Input data of FIG. 9 includes the input at 502 from pre-trained prediction model 702 (disclosed in detail below) of the utility coefficients (i.e., the estimated α, β, γ coefficients from the predictive model). At 503, the input from hotel operations is also received, such as the inventory of the number of available rooms per category based on the configuration of each hotel property as provided by the property management. For example, the hotel could be configured as having 100 rooms with two queen-size beds and 50 rooms with one king-size bed.

At 504, the optimal Lagrangian coefficients are determined to enforce room booking limits as soft constraints. At 504, the inputs include the α, β, γ utility coefficients as estimated from the predictive model (502) and per-category capacities B_{c} (503). The output is the optimal Lagrange coefficients λ*_{c},c∈C as well as optimal prices and assortment of the offers for each cluster. This problem is solved by using a standard gradient-based continuous optimization procedure, which is performed as a nested iterative process. Each iteration performed at 504 includes determining the gradient of the optimal revenue as a function of the Lagrange coefficients, which involves determining the optimal revenue R₀(λ) for the current values of the coefficients λ by solving the price optimization problem at 505 using the gradient obtained by computing (B_{c}−totalDemandEstimate), as described in equation 5 above. At 504, the iterative process converges to the optimal Lagrange coefficients

$${λ}^{*} = arg {max}_{λ} {R}_{0} ( λ )$$

At 505, the price is optimized per guest i by implementing another iterative gradient search. At 505, the inputs include the Lagrangian coefficients λ_{c} from 504 and the α, β, γ utility coefficients as estimated from prediction model 302. At 505, the output is the optimal prices p*ᵢⱼ. Each iteration of 505 involves determining the value of the optimal-order revenue function Rᵢ(pᵢⱼ,λ_{c}) by solving the offer sorting optimization problem at 507, which is then used in a standard gradient-based continuous optimization procedure such as L-BFGS-B as implemented in the “SciPy Optimize” package. As the gradient search at 505 finds only a local maxima, embodiments repeat the functionality at 505 multiple times by varying initial variable values in order to find the optimal prices

$${p}_{ij}^{*} = arg {max}_{{p}_{ij}} {R}_{i} ( {p}_{ij} , {λ}_{c} ) .$$

As function Rᵢ(pᵢⱼ, λ_{c}) may have multiple local maxima, the problem at the second step may have to be solved.

At 507, the offer order optimization for each guest i is determined. At 507, the input is: fixed prices pᵢⱼ per room category j; Lagrangian coefficients λ_{c} from 504 and utility values:
vᵢⱼ=αⱼ^{h(i)}−β^{h(i)}pᵢⱼ−γ^{h(i)}Σₘ mxᵢⱼₘ, where α, β, γ coefficients are estimated from the predictive model from 502. At 507, the output is the optimal display order (position indicator variables):
   x*ᵢⱼₘ=1 if customer i is offered room category j at position m; 0, o.w.
      Specifically, at 507, for each cluster h∈H, embodiments solve the Fractional Linear Programming (“FLP”) problem P^{RS} (equations 6-9 above) as the Linear Programming (“LP”) problem CC^{RS} (equations 10-14 above) using Charnes-Cooper (“CC”) transformation to obtain the optimal sorting of the offer for each individual cluster. Embodiments then invert the CC transformation to obtain the optimal sorting solution among the individual cluster solutions, and find the one that would maximize the cluster mix objective function of problem P^{R} as provided by equation 5 above.

The functionality of each of 504, 505 and 507 is performed iteratively to implement a gradient search at 504 and 505. Each iteration at 504 involves estimating the gradient of the function of the Lagrange coefficients by solving the optimization problem at 505, which is in turn solved iteratively with each iteration of estimating its own gradient by solving the optimization problem at 507.

At 506, the optimal room category prices and their order in the offer for each guest cluster is determined and stored in database 17 and/or higher speed memory to be used for the real-time retrieval.

Real-time portion 501 is initiated at 525 by receiving a booking request from a customer. The booking request for a specific property can include the information about the arrival and departure dates, possible discounts, booking channel, the number of people in the party including the number of children, and other attributes.

At 522, the guest booking attributes are retrieved from the booking request. The attributes include the booking channel, arrival date, number in the party, etc.

At 526, the cluster mix coefficients for the customer/guest corresponding to the booking request is determined based on the clustering model pre-trained as part of prediction model 302.

At 521, the pre-computed pricing and ordering solution for each cluster is retrieved from database 17 or higher speed memory.

At 527, solutions are determined for each cluster at 521 using the guest's personalized revenue function based on their cluster mix and the best solution is selected.

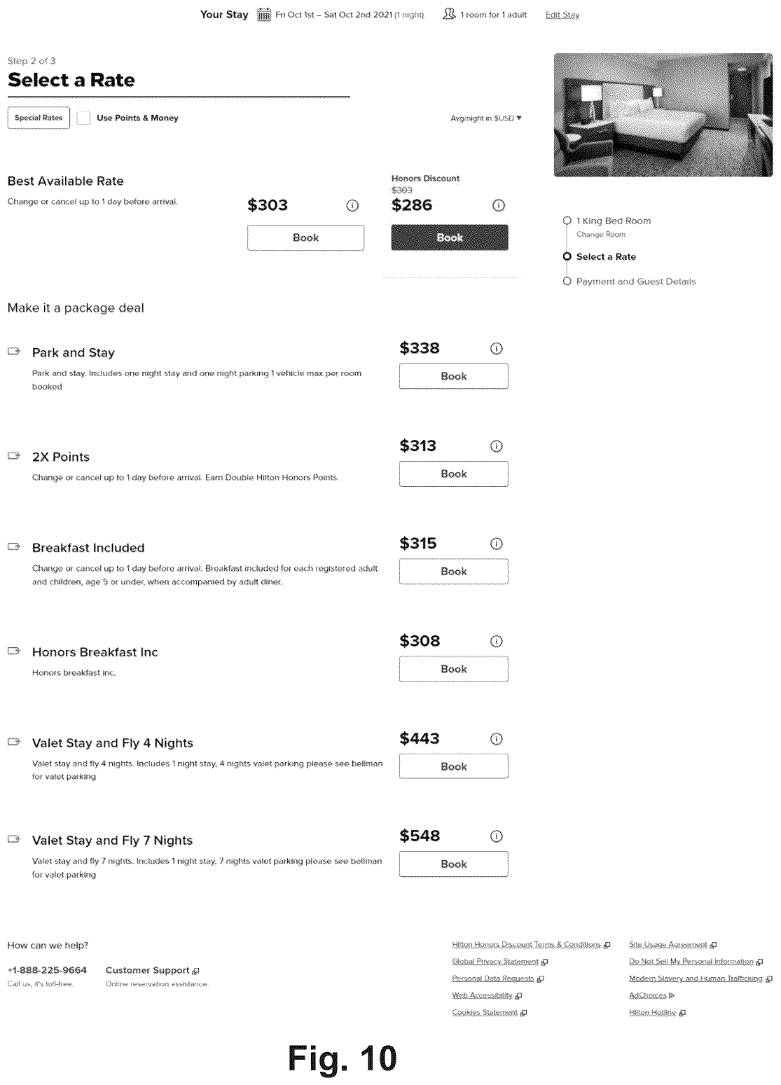

FIG. 10 illustrates an example output solution from the functionality of FIG. 9 in accordance to embodiments of the invention. As shown in FIG. 10, a specific display ordering of hotel room choices is displayed, with the display order optimizing revenue for the specific customer that provided the booking request. Further details on the functionality of optimizing pricing and display positioning that is implemented at 310 of FIG. 3 is disclosed in U.S. patent application Ser. No. 17/643,638, the incorporation of which is hereby incorporated by reference

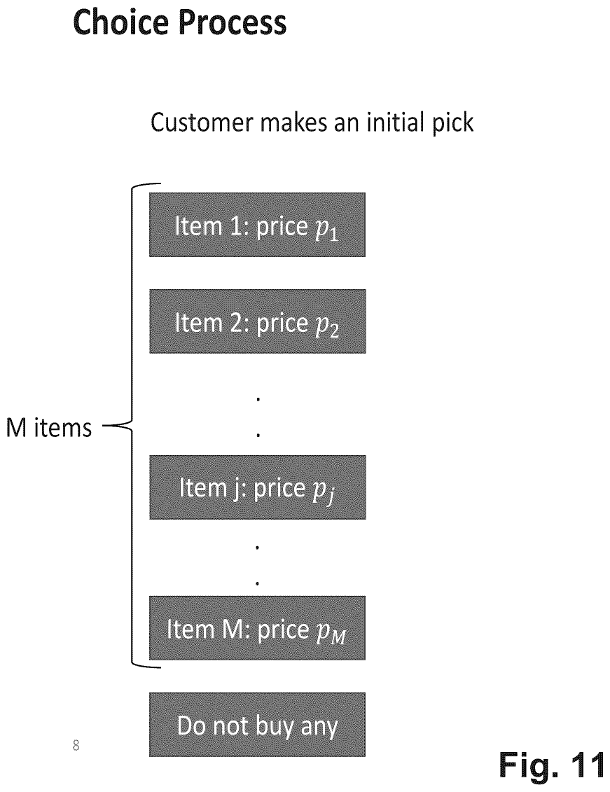

FIGS. 11-14 illustrate a sequence of events for when a customer is presented with upsell choices in accordance to embodiments of the invention.

In FIG. 11, the customer is presented with a plurality of choices (e.g., hotel room choices) Item 1-M, and makes an initial pick. The initial choice is as follows: Customer i chooses product j when (e.g., an alternative way to write the acceptance probability disclosed above):

vⱼ+ϵᵢⱼ≥max{v₀+ϵᵢ₀,v₁+ϵᵢ₁, . . . ,v_{N}+ϵ_{iN}}

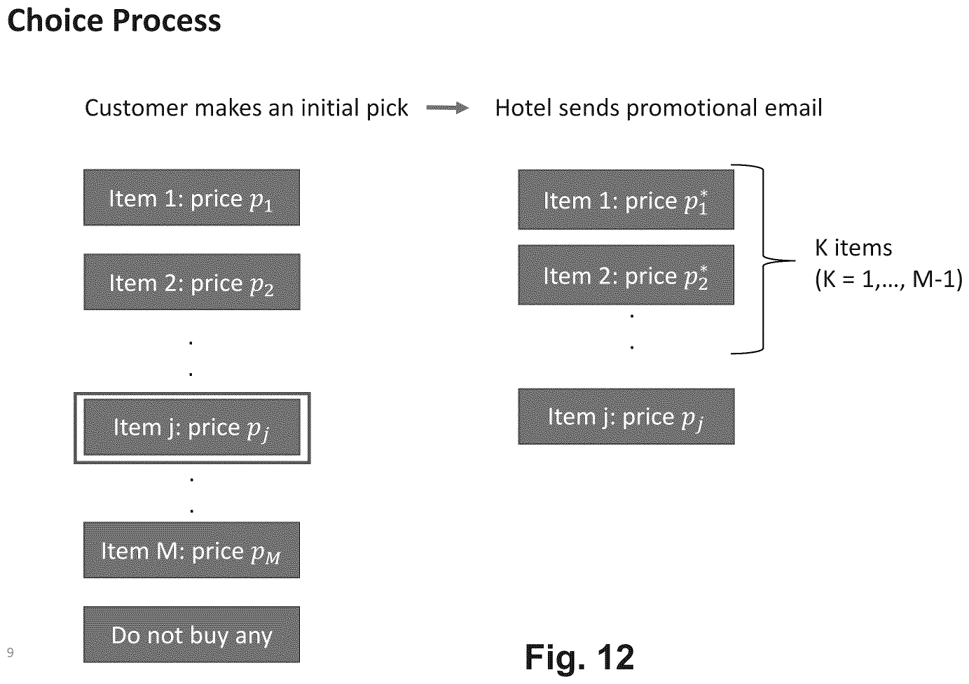

In FIG. 12, the customer makes the initial pick of Item j, and in response the hotel sends a promotion email with K items and revised pricing (to encourage upselling) for the subset of items from the initial offer except the item selected by the customer. As the selection probability depends on the display position of the item, the order of the items is optimized together with their prices. FIG. 12 illustrates an embodiment with multiple upsell offers (i.e., Item 1, Item 2, etc.) that may not include all items from the initial offer or may even consist of a single item.

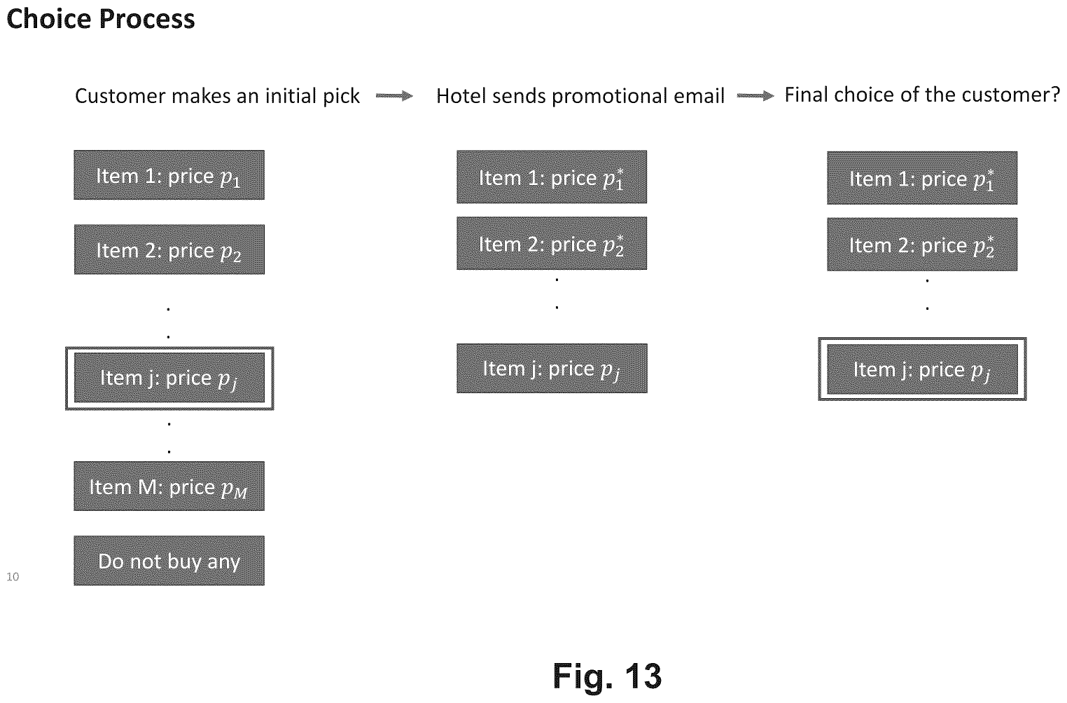

In FIG. 13, the final choice of the customer is received. As shown, in the example shown, the final choice of the customer is the original choice, Item j (i.e., the customer has not chosen any of the upsell offers. Embodiments are only interested in predicting the customer's reaction to one or more promotional offers (i.e., no initial choice predictions). In FIG. 13, the customer switches to product 2 (an alternative item) at discounted price p*₂ (accepts upgrade offer) with probability:

P(α|p*₂)=P(v₂−β(p*₂−p₂)+ϵᵢ₂>v₁+ϵᵢ₁|v₁+ϵᵢ₁≥max{v₀+ϵᵢ₀,v₁+ϵᵢ₁, . . . ,v_{N}+ϵ_{iN}})

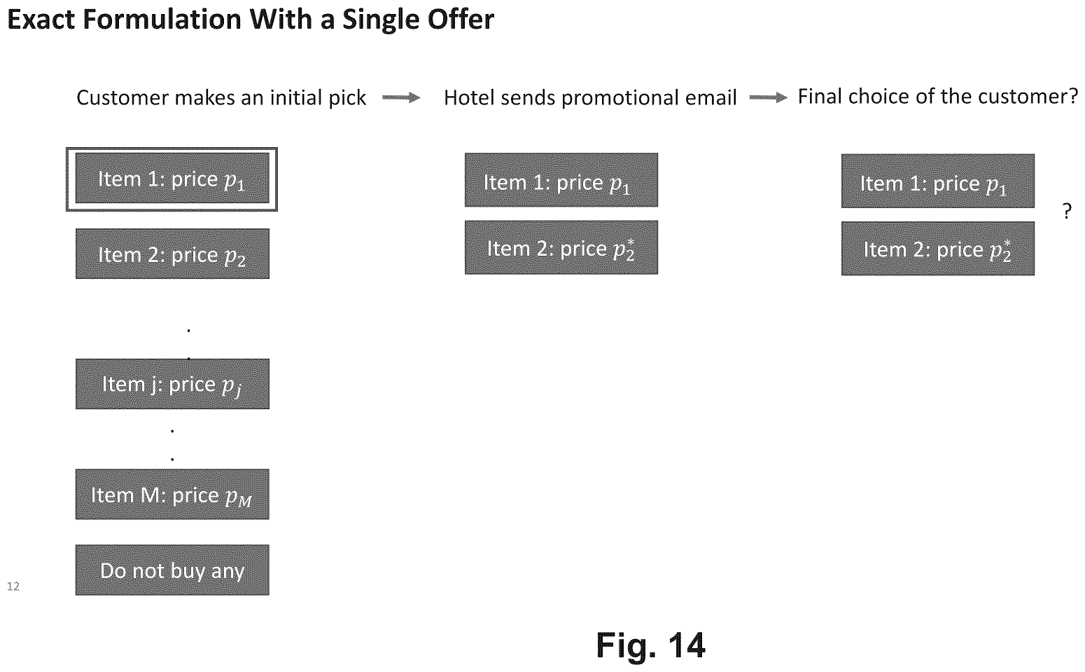

FIG. 14 illustrates an embodiment with only a single upsell offer. In this example, the customer's initial pick is Item 1, and in response Item 1 (the initial choice) and a single upsell item 2 is shown. In the example of FIG. 14, only price is optimized at 310 as there is no need to optimize display ordering since there is only a single upsell offer to choose. For the single upsell offer embodiment, when price of the item j is lowered from pⱼ to p*ⱼ, the acceptance probability of the upgrade offer acceptance is:

$${P}_{i j} ( {p}_{j}^{*} ) = \frac{{e}^{{v}_{j} - β ( {p}_{j}^{*} - {p}_{j} )} - {e}^{{v}_{j}}}{{e}^{{v}_{j} - β ( {p}_{j}^{*} - {p}_{j} )} - {e}^{{v}_{j}} + {\sum }_{{j}^{′} ∈ {S}_{i}} {e}^{{v}_{{j}^{′}}}}$$

where Sᵢ is the initial offer consideration set presented to the customer i and

$${v}_{j} = {\sum }_{k ∈ K} {α}_{k} {x}_{j k} - β {p}_{j} - γ {z}_{j}$$

In response to the pricing and optimal choices offered, embodiments accept reservations based on optimized pricing, and facilitate hotel stays based on reservations. The optimized pricing may be stored in a database in the form of specialized data. Facilitating hotel stays can include transmitting the specialized data to other specialized devices that use the data such as using the data to automatically encode hotel keys, using the data to automatically program hotel room door locks, etc.

Referring again to FIG. 3, the result of the customer's “final” choice (i.e., either the initial choice or an upsell choice) is stored in database 352 as an additional observation of demand. The observed choice is input at 304, which results in an iterative process in which the model at 308 is ultimately retrained.

As disclosed, embodiments in general solve at least two main problems: modeling the discrete-choice demand as driven by the several selected features and determining their relative weights. As the features include the price of each choice, the solution to the problem allows for a monetary estimate of each feature based on the guests' willingness to pay. For example, embodiments can estimate the guests' willingness to pay for the upgrade to a larger room or a room with a better view.

In a first step, the hotel room features are extracted from the natural language room description as uni- bi- and trigrams, that is, one, two, or three consecutive words, and an approximate demand modeling problem is solved, which essentially models every single choice separately as a binary outcome. Since the number of the n-grams features can be very large, this simplified modeling approach provides an efficient mechanism to process all initial features. The feature selection is achieved by so-called L1 regularization that adds a linear penalty function of the feature value to the likelihood estimator, which results in some of the feature values becoming zero in the optimal solution. The computation of the penalized maximum likelihood estimator (“MLE”) is performed by using a stochastic gradient descent (“SGD”) algorithm, which allows for fast convergence to the optimal function value. After the initial selection of the room features, the interaction variables for the guest booking attributes are added to the model in order to estimate the variability of each feature value among different guest types. For example, such features as booking price and room size may have different values for the guests booking on corporate or personal accounts. In this case, the interaction variable expressed as the product of price variable and corporate account binary variable expresses the changes in price sensitivity between customers using corporate and personal accounts. The feature selection process described above is then re-applied in order to filter out insignificant interaction variables. The remaining interaction variables are then used to estimate the relative weights of the guest booking attributes that are used for clustering at the next step.

A second step begins with soft clustering of the hotel guests and the application of the modified multinomial logit (“MNL”) model to each cluster of the hotel guests. The idea behind soft clustering is that a guest can belong to more than one category or cluster. For example, a guest could be split 40/60 between leisure and vacation categories reflecting the uncertainty of the nature of their stay. As the clustering is unsupervised learning, traditionally, all variables are scaled to the same standard deviation, usually one. However, in embodiments, the variables are scaled to the standard deviation proportional to their logistic regression coefficients obtained at the previous step to reflect their predictive power for the guests' choices. After scaling is performed, the MNL-based upsell-predicting model is trained separately for each cluster with the choice outcome split proportionally to the guest's assignment to the cluster.

The upsell model that is used in embodiments reflects each guest's previous choice for the current room type and the probability of the future upsell choice is calculated as conditional on the previous choice. The model is fit by applying the MLE method. In this case, in order to improve the model stability due to the potential collinearity of some variables, the L2 regularization is applied by adding a term proportional to the square of the variable coefficient value. Since this term is a smooth function, it is still possible to use standard quasi-Newton gradient search algorithms. In embodiments, a packages L-BFGS method may be used. The Hessian matrix of the second derivatives estimated as “by-product” of this algorithm is used to obtain the confidence intervals of the coefficients by computing the Fisher information matrix.

Finally, the k-fold (k=5) cross-validation of the model is used to find the optimal setting of the hyper-parameters including the number of clusters and the values of the regularization penalties.

Novel functionality of embodiments of the invention include: (1) The extraction from the natural language description of the hotel rooms; (2) Feature selection through fast-converging logistic regression using SGD and L1 penalty; (3) Usage of the guest attributes and room feature interaction variables for the personalized prediction models; (4) Soft clustering of the guests using their attribute weights; and (5) Application of the MNL-based upsell-predicting model.

Advantages of embodiments of the invention include: (1) An interpretable model providing managerial insight into the relative importance of the room features; (2) Automated feature extraction that eliminates manual feature editing and entering; (3) Monetary measuring for room features; (4) Estimation of guests' willingness to pay based on their booking attributes; (5) Increased accuracy and stability of the predictive model; and (6) Guaranteed monotonicity of the prediction: the model would predict lower choice probability when its price is increased.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of upselling a hotel room selection, the method comprising:
providing a first plurality of hotel room choices, each first plurality of hotel room choices comprising a first type of hotel room and a corresponding first price;
receiving a first selection of one of the first plurality of hotel room choices; and
in response to the first selection, providing a second plurality of hotel room choices, the second plurality of hotel room choices comprising a subset of the first types of hotel room choices and a corresponding optimized price that is different from the respective corresponding first price.

2. The method of claim 1, further comprising:
receiving a plurality of textual room descriptions that define different types of hotel rooms; and
data mining the plurality of textual room descriptions to generate a plurality of features comprising a plurality of unigrams, bigrams and trigrams.

3. The method of claim 2, further comprising:
selecting a subset of the plurality of features using regularized logistic regression.

4. The method of claim 3, further comprising:
generating and training an upsell predictive model using the subset of features, the upsell predictive model comprising a Multinomial Logit (MNL) model.

5. The method of claim 4, the providing the first plurality of hotel room choices is provided to a customer, further comprising using soft clustering to assign the customer to one or more of a plurality of clusters.

6. The method of claim 4, the training using a likelihood maximization and comprising estimating parameters.

7. The method of claim 6, further comprising:
receiving a second selection of one of the second plurality of hotel room choices;
based on at least the second selection, re-training the MNL model.

8. The method of claim 1, further comprising optimizing a display order of the second plurality of hotel room choices.

9. A computer readable medium having instructions stored thereon that, when executed by one or more processors, cause the processors to upsell a hotel room selection, the upselling comprising:
providing a first plurality of hotel room choices, each first plurality of hotel room choices comprising a first type of hotel room and a corresponding first price;
receiving a first selection of one of the first plurality of hotel room choices; and
in response to the first selection, providing a second plurality of hotel room choices, the second plurality of hotel room choices comprising a subset of the first types of hotel room choices and a corresponding optimized price that is different from the respective corresponding first price.

10. The computer readable medium of claim 9, the upselling further comprising:
receiving a plurality of textual room descriptions that define different types of hotel rooms; and
data mining the plurality of textual room descriptions to generate a plurality of features comprising a plurality of unigrams, bigrams and trigrams.

11. The computer readable medium of claim 10, the upselling further comprising:
selecting a subset of the plurality of features using regularized logistic regression.

12. The computer readable medium of claim 11, the upselling further comprising:
generating and training an upsell predictive model using the subset of features, the upsell predictive model comprising a Multinomial Logit (MNL) model.

13. The computer readable medium of claim 12, the providing the first plurality of hotel room choices is provided to a customer, further comprising using soft clustering to assign the customer to one or more of a plurality of clusters.

14. The computer readable medium of claim 12, the training using a likelihood maximization and comprising estimating parameters.

15. The computer readable medium of claim 14, the upselling further comprising:
receiving a second selection of one of the second plurality of hotel room choices;
based on at least the second selection, re-training the MNL model.

16. The computer readable medium of claim 9, the upselling further comprising optimizing a display order of the second plurality of hotel room choices.

17. A hotel reservation system that upsells a hotel room selection comprising:
one or more processors coupled to stored instructions;
a first database storing textual hotel room descriptions that define different types of hotel rooms; and
a second database storing hotel room demand observation;
the processors configured to:
provide a first plurality of hotel room choices, each first plurality of hotel room choices comprising a first type of hotel room and a corresponding first price;
receive a first selection of one of the first plurality of hotel room choices; and
in response to the first selection, provide a second plurality of hotel room choices, the second plurality of hotel room choices comprising a subset of the first types of hotel room choices and a corresponding optimized price that is different from the respective corresponding first price.

18. The hotel reservation system of claim 17, the processors further configured to:
data mine the plurality of textual room descriptions to generate a plurality of features comprising a plurality of unigrams, bigrams and trigrams.

19. The hotel reservation system of claim 18, the processors further configured to:
select a subset of the plurality of features using regularized logistic regression.

20. The hotel reservation system of claim 19, the processors further configured to:
generate and train an upsell predictive model using the subset of features, the upsell predictive model comprising a Multinomial Logit (MNL) model.
